(19) United States
(12) Patent Application Publication
(10) Pub. No.: US 2012/0260039 A1
(43) Pub. Date: Oct. 11, 2012

(54) METHOD AND A REMOVABLE DEVICE FOR BACKING UP AND RESTORING A HOST DEVICE

(75) Inventors: WILLIAM WEIHAN YAO, Irvine, CA (US); RAYMOND PATRICK MCGOLDRICK, Laguna Hills, CA (US); HIROSHI NISHIMURA, Irvine, CA (US)

(73) Assignee: NTI CORPORATION, Irvine, CA (US)

(21) Appl. No.: 13/082,659

(22) Filed: Apr. 8, 2011

(51) Int. Cl. G06F 12/16

(52) U.S. Cl. 711/115; 711/E12.103

(57) ABSTRACT

A method and a removable device for backing up/restoring a host device are disclosed. A portable application is resident in a removable device, which is external to the host device and is capable of being electrically coupled to the host device. The portable application is launched to the host device after the removable device is coupled to the host device. If a backup function is selected, a backup process begins by moving data to be backed up from the host device to the removable device; and if a restore function is selected, a restore process begins by moving data to be restored from the removable device to the host device.

### BACKGROUND OF THE INVENTION

1. Field of the Invention

The present invention generally relates to data backup and restore, and more particularly to a method and a removable device using a portable application for backing up and/or restoring data.

2. Description of Related Art

Data backup is a process of making one or more copies of data from a host device to an external device or devices. The data backup is commonly, but not exclusively, used to recover the host device by restoring the backup data to the host device in case of data loss in the host device. For example, it is not uncommon that an operating system of a host device such as a personal computer fails. It is also a usual scenario, for instance, that a hard disk of the host device cannot be read normally. A user of the personal computer may negligently delete files, that are supposed to be retained, from the hard disk at times. In order to recover the corrupt host device, a data restore process needs to be adopted to move the backup file or files back to the host device.

The backup files are conventionally stored in a fixed apparatus such as a file server. One of disadvantages of backing up files in the file server is the lack of mobility and flexibility in use. Although compact disk (CD) has been used as a removable storage device for backing up files, the CD is limited in its capacity. Another disadvantage of the conventional backup/restore technique is that the content of the backup files is not updated most recently. Further, the content of the backup files cannot be used to restore or update a number of computers separately because distinct computers may have a different system description.

For the reason that conventional technique could not effectively be used to perform a backup/restore process, a need has arisen to propose a novel backup/restore scheme that provides a mobile, customized, flexible and convenient solution to users.

### SUMMARY OF THE INVENTION

In view of the foregoing, it is an object of embodiments of the present invention to provide a method and a removable device for backing up/restoring a host device. The removable device may substantially protect a host device through complete system backup or restore without installing backup/restore programs in the host device.

According to one embodiment, a removable device capable of backing up/restoring a host device includes a portable application resident in the removable device, which is external to the host device and is capable of being electrically coupled to the host device. The portable application is launched to the host device after the removable device is coupled to the host device. If a backup function is selected, a backup process begins by moving data to be backed up from the host device to the removable device; and if a restore function is selected, a restore process begins by moving data to be restored from the removable device to the host device.

### BRIEF DESCRIPTION OF THE DRAWINGS

FIG. 1 shows a schematic block diagram illustrating a removable device for backing up and restoring a host device according to one embodiment of the present invention;

FIG. 2 shows a flow diagram illustrative of backing up and/or restoring the host device by the removable device of FIG. 1 according to one embodiment of the present invention;

FIG. 3A to FIG. 3G show exemplary graphical user interface (GUI) display images during the backup and restore process; and

FIG. 4 shows a data flow of a backup/restore engine in the portable application according to one embodiment of the present invention.

### DETAILED DESCRIPTION OF THE INVENTION

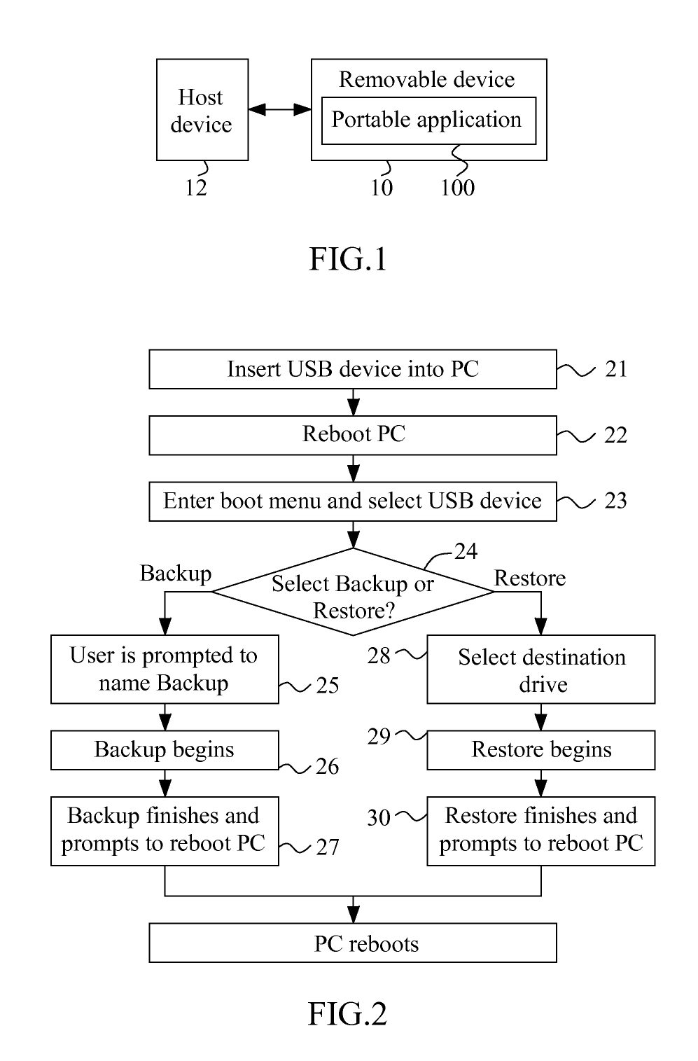

FIG. 1 shows a schematic block diagram illustrating a removable device 10 with a resident portable application 100 that is capable of backing up and restoring a host device 12 according to one embodiment of the present invention. The removable device 10 is external to the host device 12 and may be electrically coupled to the host device 12 when necessary. The removable device 10 may preferably be, but not limited to, a removable storage device such as a Universal Serial Bus (USB) hard drive, a USB flash drive, a memory card or a solid-state drive (SSD). The host device 12 may generally be a computer such as, but not limited to, a personal computer (PC), a notebook computer or a pocket PC.

In the embodiment, the portable application 100, also known as portable software or green software, is a computer program resident in the removable device 10 and is adapted to back up and/or restore the host device 12 upon execution. The portable application 100 can run from the removable device 10 without installing it on the host device 12. Details about how to launch a portable application upon insertion of a removable media into a computer device may be referred to U.S. Pat. No. 6,529,992, entitled “Self-Contained Application Disk for Automatically Launching Application Software or Starting Devices and Peripherals,” the disclosure of which is hereby incorporated by reference.

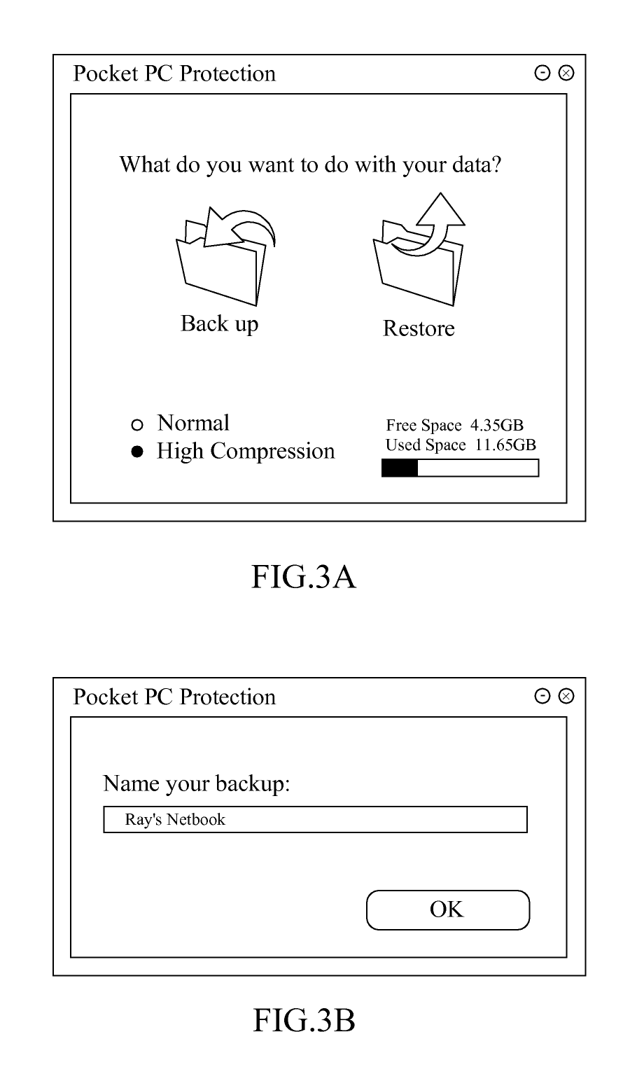

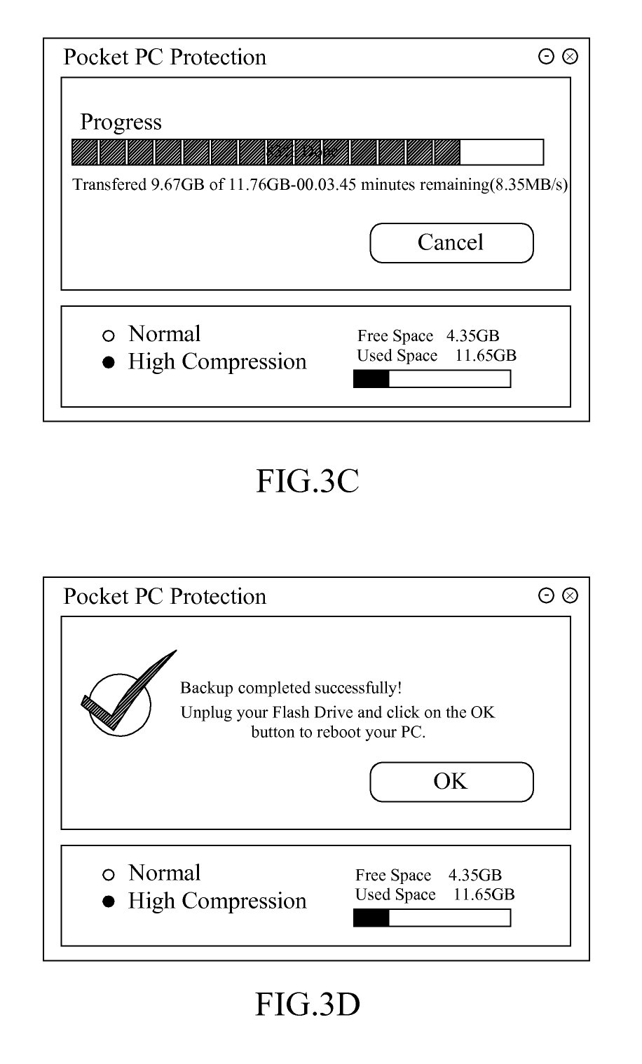

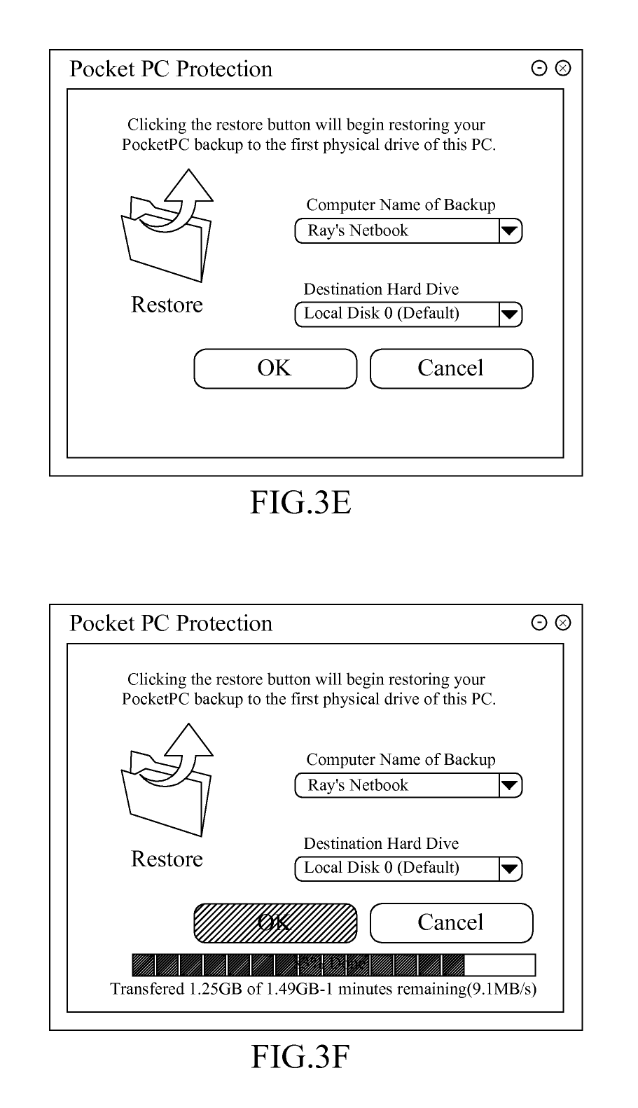

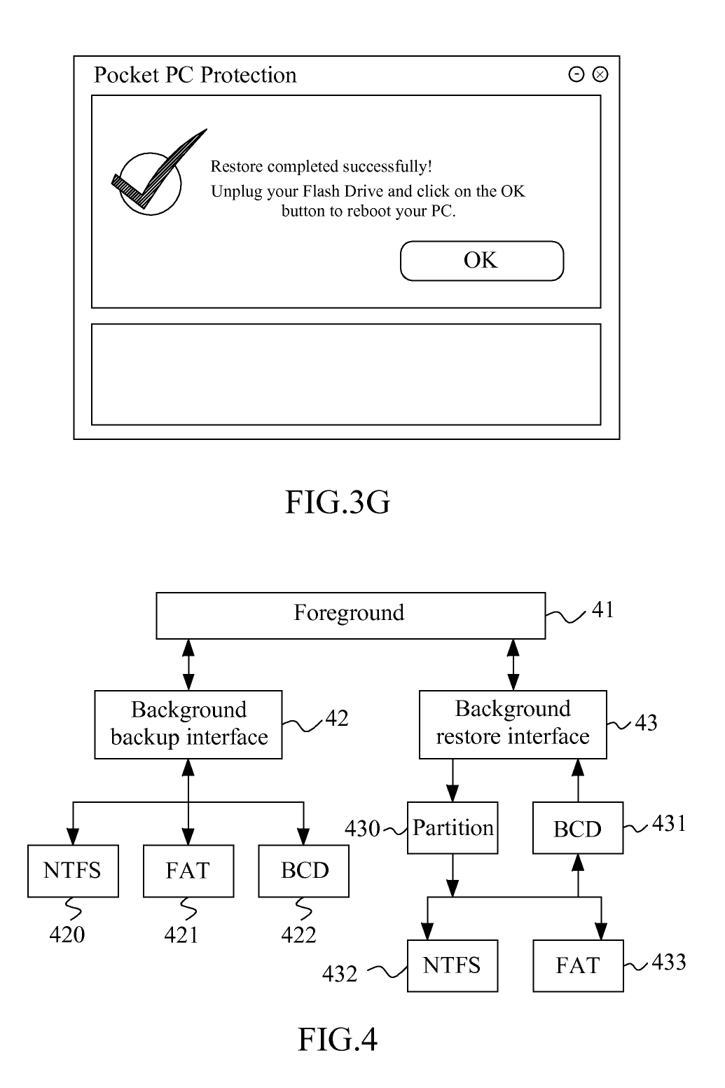

FIG. 2 shows a flow diagram illustrative of backing up and/or restoring the host device 12 by the removable device 10 according to one embodiment of the present invention. In the embodiment, the removable device 10 is a USB device and the host device 12 is a PC. In step 21, the USB device is inserted into the PC by a user, and the PC is then rebooted (step 22). It is noted that, in another embodiment, the USB device may be hot plugged into the PC without rebooting the PC. Subsequently, in step 23, the user presses a predetermined key (e.g., a function key) on the PC to enter a boot menu, from which the USB device may be selected by the user. In step 24, the main program of the portable application then launches into the PC, and a user interface such as the graphical user interface (GUI) as exemplified in FIG. 3A provides buttons that allow the user to select Backup or Restore. It is especially noted that if no backup has been completed, the Restore button will be inactivated, for example, by graying out the Restore button.

If the backup button is selected in step 24, a backup name window (FIG. 3B) pops up, in step 25, to prompt the user to enter a backup name. After entering the backup name, the backup process begins (step 26) by moving data to be backed up from the PC to the USB device. FIG. 3C shows an exemplary user interface showing progress of the backup process. For example, a progress bar displays in real-time the amount of data being transferred from the total size (e.g., in GB), the estimated time remained and the speed of the data transferring (in MB/s). In one embodiment, before executing the backup process, the program ordinarily determines whether there is enough space in the USB device to accommodate to-be-backed-up data moved from the PC to the USB device. In a further embodiment, before executing the backup process, the program judges whether a predetermined drive (such as a default physical first drive) has already been backed up. If it judges the first drive has already been backed up, the user is further prompted to confirm backing up the first drive by overwriting. Finally, in step 27, the backup process finishes and a button is shown (FIG. 3D) to prompt the user to reboot the PC. In another embodiment, the PC automatically reboots without user's intervention.

On the other hand, if the user selects the restore button in step 24, the flow proceeds to the restore process. In step 28, as exemplified in FIG. 3E, the user either accepts the default drive (e.g., the physical first drive on the PC) as the destination drive to be restored, or selects a different destination drive, for example, via a dropdown box. After confirming the destination drive to be restored, the restore process begins (step 29). Before executing the restore process, the program ordinarily determines whether there is enough space in the PC to accommodate the to-be-restored data moved from the USB device to the PC. FIG. 3F shows an exemplary user interface showing progress of the restore process. For example, a progress bar displays in real-time the amount of data being transferred from the total size (e.g., in GB), the estimated time remained and the speed of the data transferring (in MB/s). Finally, in step 30, the restore process finishes and a button is shown (FIG. 3G) to prompt the user to reboot the PC. In another embodiment, the PC automatically reboots without user's intervention.

FIG. 4 shows a data flow of a backup/restore engine in the portable application 100 according to one embodiment of the present invention. In the embodiment, a foreground-background scheduling algorithm is adopted to control execution of the backup/restore process. When the main program of the portable application 100 launches into the PC, the main program immediately begins its execution in the foreground 41 for a predetermined period, during which the foreground procedure executes some checking tasks such as determining whether there is enough space in the USB device to perform the backup or determining whether there is enough space in the PC to perform the restore. The process is then moved to the background procedure via a background backup interface 42 or a background restore interface 43. With respect to the backup process, the background backup procedure, for example, performs backing up a file system such as New Technology File System (NTFS) 420 or File Allocation Table (FAT) 421, and checks configuration data such as Boot Configuration Data (BCD) 422. With respect to the restore process, the background restore procedure, for example, restores partition data 430, BCD 431, NTFS 432 or FAT 433 to the PC. Generally speaking, information to be backed up or restored may be file data or non-file data such as system description, boot sector, partition layout, file metadata or system metadata. After the background procedure finishes the backup or restore, the process is then moved back to the foreground 41.

According to the embodiment described above, the portable application is capable of performing complete system backup or restore of the entire PC, therefore substantially protecting the PC. Moreover, the required program can run from the USB device without installing it on the PC. Everything required to backup and restore the entire PC resides on the USB device that can be carried anywhere.

Although specific embodiments have been illustrated and described, it will be appreciated by those skilled in the art that various modifications may be made without departing from the scope of the present invention, which is intended to be limited solely by the appended claims.

What is claimed is:

1. A method of backing up/restoring a host device, comprising:
providing a portable application resident in a removable device, which is external to the host device and is capable of being electrically coupled to the host device;
launching the portable application to the host device after coupling the removable device to the host device;
if a backup function is selected, beginning a backup process by moving data to be backed up from the host device to the removable device; and
if a restore function is selected, beginning a restore process by moving data to be restored from the removable device to the host device.

2. The method of claim 1, wherein the removable device is a removable storage device.

3. The method of claim 2, wherein the removable storage device is a Universal Serial Bus (USB) hard drive, a USB flash drive, a memory card or a solid-state drive (SSD).

4. The method of claim 1, wherein the host device is a computer.

5. The method of claim 1, before the backup process step, further comprising:
determining whether there is enough space in the removable device to accommodate the data to be backed up.

6. The method of claim 1, before the backup process step, further comprising:
judging whether a predetermined drive has already been backed up; and
if judged that the predetermined drive has been backed up, prompting a user to confirm performing the backup process step.

7. The method of claim 1, before launching the portable application to the host device, further comprising:
rebooting the host device after coupling the removable device to the host device; and
selecting the removable device in the host device.

8. The method of claim 1, before the restore process step, further comprising:
determining whether there is enough space in the host device to accommodate the data to be restored.

9. The method of claim 1, before the restore process step, further comprising:
selecting a drive as a destination drive of the host device to be restored.

10. The method of claim 1, wherein the data to be backed up and the data to be restored is file data.

11. The method of claim 1, wherein the data to be backed up and the data to be restored is non-file data.

12. The method of claim 11, wherein the non-file data is system description, boot sector, partition layout, file metadata, system metadata or a combination thereof.

13. The method of claim 1, wherein the backup process step or the restore process step comprises:
the portable application beginning execution in a foreground procedure;
the portable application moving to a background procedure to move the data to be backed up or restored; and
the portable application moving back to the foreground procedure before the backup process step or the restore process step finishes.

14. A removable device capable of backing up/restoring a host device, comprising:
a portable application resident in the removable device, which is external to the host device and is capable of being electrically coupled to the host device;
wherein the portable application is launched to the host device after the removable device is coupled to the host device; if a backup function is selected, a backup process begins by moving data to be backed up from the host device to the removable device; and if a restore function is selected, a restore process begins by moving data to be restored from the removable device to the host device.

15. The removable device of claim 14, wherein the removable device is a removable storage device.

16. The removable device of claim 15, wherein the removable storage device is a Universal Serial Bus (USB) hard drive, a USB flash drive, a memory card or a solid-state drive (SSD).

17. The removable device of claim 14, wherein the host device is a computer.

18. The removable device of claim 14, wherein before beginning the backup process, the portable application further determines whether there is enough space in the removable device to accommodate the data to be backed up.

19. The removable device of claim 14, wherein before beginning the backup process, the portable application further judges whether a predetermined drive has already been backed up; and if it is judged that the predetermined drive has been backed up, the portable application prompts a user to confirm performing the backup process.

20. The removable device of claim 14, wherein after the removable device is coupled to the host device and before the portable application is launched to the host device, the host device is rebooted and the removable device in the host device is selected.

21. The removable device of claim 14, wherein before beginning the restore process, the portable application further determines whether there is enough space in the host device to accommodate the data to be restored.

22. The removable device of claim 14, wherein before beginning the restore process, the portable application further selects a drive as a destination drive of the host device to be restored.

23. The removable device of claim 14, wherein the data to be backed up and the data to be restored is file data.

24. The removable device of claim 14, wherein the data to be backed up and the data to be restored is non-file data.

25. The removable device of claim 24, wherein the non-file data is system description, boot sector, partition layout, file metadata, system metadata or a combination thereof.

26. The removable device of claim 14, wherein in the backup process or the restore process, the portable application is configured to:
begin execution in a foreground procedure;
move to a background procedure to move the data to be backed up or restored; and
move back to the foreground procedure before the backup process or the restore process finishes.
